(19) United States
(12) Patent Application Publication
(10) Pub. No.: US 2025/0353023 A1
(43) Pub. Date: Nov. 20, 2025

(54) CENTRIFUGE FOR CONTINUOUSLY MONITORING AND MEASURING THE COLOR OF A MASSECUITE OVER THE ENTIRE HEIGHT OF THE CENTRIFUGE BASKET

(71) Applicant: ITECA SOCADEI, Aix-en-Provence (FR)

(72) Inventor: Bertrand GAILLAC, Vitrolles (FR)

(73) Assignee: ITECA SOCADEI, Aix-en-Provence (FR)

(21) Appl. No.: 18/873,078

(22) PCT Filed: Jun. 6, 2023
(86) PCT No.: PCT/FR2023/050796

§ 371 Date: Dec. 9, 2024

(30) Foreign Application Priority Data
Jun. 7, 2022 (FR) 22/05450

(51) Int. Cl. B04B 11/04; B04B 3/00; B04B 15/12; C13B 30/10

(52) U.S. Cl. CPC B04B 11/043; B04B 3/00; B04B 15/12; C13B 30/10

(57) ABSTRACT

A centrifuge for separating, in a massecuite, a quantity of sugar crystals from a syrup, the centrifuge including at least: a centrifuge basket into which the massecuite is intended to be introduced, and which has a peripheral wall; a measurement device including at least one light source designed to illuminate the peripheral wall over at least 90% of its height; and a photodetection system designed to detect light reflected by the peripheral wall over at least 90% of its height and to deliver photodetection measurements which are representative of the massecuite accumulating on the peripheral wall or of the peripheral wall itself; and a processing unit connected to the measurement device and designed to continuously process the photodetection measurements in real time.

### TECHNICAL FIELD

The invention relates to a centrifuge used for separating, in a massecuite, a quantity of sugar crystals from a syrup.

It relates more particularly to a centrifuge comprising a measuring apparatus for performing photodetection measurements on the massecuite contained in the centrifuge basket of the centrifuge.

The invention also relates to a method for centrifugal spinning, in a massecuite, of a quantity of sugar crystals from a syrup using this centrifuge.

Such a centrifuge and such a method find an industrial application in the sugar manufacturing cycle, by increasing the yield and improving one of its steps called the spinning step.

### PRIOR ART

In a known manner, the industrial manufacture of a quantity of sugar as a finished product from a so-called sugar plant (the two main ones being sugar cane and sugar beet) is marked out by several steps all involving both equipment and processes/methods specific to them.

The sugar plant, once harvested, is first washed to remove external impurities (soil, stones, plant debris, . . . ). This is followed by a so-called extraction step, which consists in extracting a sweet juice from the sugar plant. The extraction method differs depending on the sugar plant considered: extraction is carried out by grinding in the case of sugar cane, and by grating then diffusion in the case of sugar beet. The sweet juice then undergoes treatments in order to eliminate all impurities (mineral salts, organic compounds . . . ) and the water it may contain. Following these treatments, a juice concentrated in sugar, also called syrup, is then obtained. The syrup is introduced, during a so-called crystallization/refining step, into a cooking boiler under vacuum and seeded with very fine sugar crystals in order to generate and then finalize its crystallization. The crystallization method allows the sugar to be extracted from the syrup by forming crystals made up of more than 99% sucrose molecules.

This produces a massecuite, that is to say a syrup depleted of a large part of its sugar, also called “mother liquor”, containing multiple small suspended sugar crystals, and which is colored by the presence of residual impurities. The next step, called the spinning step, consists in washing and separating the sugar crystals from the syrup. The sugar crystals, once separated from the syrup and collected, are dried then packaged in order to be presented in the form of a finished product (in the form of powder in bags; in pieces in boxes, etc.).

The mother liquor from the first spinning step still contains sucrose molecules that need to be extracted, this mother liquor is again concentrated in the form of syrup that is boiled to be transformed into a new/second massecuite that undergoes a new spinning step in order to extract a light brown crystallized sugar called “second-grade” sugar, which is less pure than the sugar collected during the first spinning called “first-grade” sugar and which has a white color, as it contains residual impurities (including minerals such as calcium). These sugar crystals are remelted to be added to the first-grade syrup. The mother liquor from the second spinning can also undergo a new boiling step to transform it into a third massecuite that is subjected to a third spinning step. A so-called “third-grade” sugar that is less pure than the second-grade sugar and has a dark brown/brown color is then collected. This sugar is commonly called brown sugar. The residual mother liquor remaining after this third spinning, called molasses, can generally undergo no further treatment, and is intended for the distillery.

Spinning is generally carried out using centrifuges classified into two categories: continuous centrifuges and batch centrifuges. The type of centrifuge used during the spinning step(s) depends on the purity of the massecuite and the expected quality of the sugar. Usually, batch centrifuges with a better yield are used for the extraction of first-grade sugar crystals, while continuous centrifuges are used for the extraction of second- and third-grade sugar crystals. In the case of continuous centrifuges, during the spinning step, the centrifuge basket of the centrifuge is continuously supplied with massecuite at a variable or piloted flow rate while it is driven in rotation at a constant speed. In batch centrifuges, the massecuite is introduced at once upstream at the start of the spinning cycle defining the spinning step, it being understood that the rotation speed of the basket is not constant during the spinning cycle.

The massecuite is introduced into a basket included in the centrifuge, which basket has a permeable peripheral wall over its entire height, this generally being in the form of a woven filter cloth, conventionally made of stainless steel, provided with perforations and commonly called a centrifugal machine cloth.

Under the action of the centrifugal force created by the speed of the basket, the sugar crystals are separated from the syrup (mother liquor) which is evacuated through the perforations of the basket and collected in a chamber provided for this purpose. The dimensions of the perforations are such that the sugar crystals cannot pass through.

One or two washing steps occur during the centrifugation phase to clean the crystals of their impurities and mother liquor which are stuck to their surface.

In the case of batch centrifuges, the sugar crystals when separated from the syrup remain on the surface of the basket cloth, which is cylindrical in shape. The bottom wall is provided with a plug which is closed throughout the duration of the spinning, then opened at the end of the latter in order to discharge the quantity of sugar crystals into a chamber provided for this purpose. The discharge is performed at low speed of the basket by means of a scraper which removes the sugar over the entire height of the cloth and which makes it fall into the bottom wall which is at that moment open.

The still wet sugar crystals then fall onto a conveyor which will take them to the dryer.

In the case of continuous centrifuges, the basket is frustoconical in shape and has an upper edge delimiting an upper opening of said basket. During spinning, under the action of centrifugal force, the sugar crystals rise along the inclined peripheral wall of the basket and are evacuated by overflowing the basket, at the upper edge, into a chamber provided to collect them.

It is also conventional, during centrifugal spinning, to accelerate the separation of sugar crystals from the syrup by washing the massecuite, which consists in spraying water and/or clear syrup onto the massecuite by means of jets installed in the centrifuge. Washing requires good mastering of the quantity of water or clear syrup sprayed onto the massecuite in order to avoid the spray dissolving the sugar crystals.

In order to better master the washing step so that spinning becomes faster and more efficient in a more global way, the centrifuges can be equipped today with monitoring/measuring apparatus making it possible to monitor: for batch centrifuges, the color of the massecuite which depends on the concentration of sugar in the syrup and also on the presence of residual impurities; for continuous centrifuges, the color of the massecuite and/or the sugar crystals deposited on the inclined peripheral wall of the basket (the lighter the color, the more it means that the sugar crystals are separated from the syrup and cleaned of any impurities).

Several monitoring/measuring apparatuses have been proposed in the literature such as EP2275207, EP3356051, WO2020094217. The monitoring/measuring apparatuses proposed in these documents comprise a light source intended to illuminate the massecuite contained in the centrifuge basket, and a photodetection system intended to convert the light signals reflected by the massecuite into electrical signals, which electrical signals must make it possible, after treatment, to determine the color of the massecuite. For each monitoring apparatus, a method for measuring the color of the massecuite is also proposed.

The methods described in EP3356051 and WO2020094217 also comprise a step of washing the massecuite triggered if the color of the massecuite does not correspond to a setpoint color, this setpoint color being used to establish whether the sugar crystals are properly separated from the syrup. The monitoring apparatus disclosed in EP2275207 finds an application for batch centrifuges (note that the apparatus is positioned inside the centrifuges); those of EP3356051 and WO2020094217 for continuous and batch centrifuges, and can be placed both outside and inside the centrifuges.

However, the monitoring/measuring apparatuses disclosed in these three prior documents are only intended to illuminate a single restricted or localized area of the peripheral wall of the basket and thus allow the color of the massecuite to be monitored only locally. Thus, in EP2275207, the RGB sensor (Red, Green, Blue) included in the photodetection system is limited to an illumination area of a few centimeters, resulting in a very local and limited measurement of the color of the massecuite. In EP3356051 and WO2020094217, although capable of measuring in a very wide range of wavelengths, the monitoring apparatuses make it possible to determine the color of the massecuite only on a restricted scale of the wall height of the centrifuge basket.

Determining the color of the massecuite locally on an area of the peripheral wall of the centrifuge basket implies at the time t of this determination a lack of knowledge of the color on the rest of the massecuite. To observe the plurality of colors that the entire surface of the massecuite can take, it is necessary, if at all possible, to manually or automatically move the monitoring apparatus as many times as necessary. However, in addition to being particularly restrictive, it is possible that the color of the massecuite in an area already observed has evolved during the movement of the apparatus in order to observe the color of the massecuite in another area.

In addition, in the case of the continuous centrifuge, there is a dark/light interface area at the bottom of the basket that gives an indication of the fluidity of the massecuite, an area that must also be monitored in order to improve the efficiency of spinning.

Since the aforementioned monitoring apparatuses only provide a very localized view of an area of the massecuite, they cannot, at the same time, monitor the interface area.

Another disadvantage is that the operator must only rely on the result of the color determination that they provide without having any means of monitoring for himself how the massecuite evolves in the centrifuge basket. This disadvantage makes monitoring of the spinning step inefficient.

In conclusion, these disadvantages are all obstacles impacting the efficiency of the spinning step and the time required to carry it out.

### SUMMARY OF THE INVENTION

The invention proposes to address the aforementioned problem by providing a solution to improve monitoring of the spinning step.

To this end, the invention proposes a centrifuge for separating, in a massecuite, a quantity of sugar crystals from a syrup, the centrifuge comprising at least:
a centrifuge basket actuated in rotation about a central axis of rotation, in which the massecuite is intended to be introduced, said centrifuge basket having a bottom wall and a peripheral wall, said peripheral wall being permeable and having a lower edge contiguous to said bottom wall and an upper edge, and wherein said peripheral wall has a height measured from the lower edge to the upper edge;
a measuring apparatus comprising at least one light source for illuminating the interior of the centrifuge basket and a photodetection system for detecting reflected light and delivering photodetection measurements that are representative of the massecuite or the peripheral wall; and
a processing unit connected to the measuring apparatus to receive and process said photodetection measurements;
said centrifuge being characterized in that the light source is designed to illuminate the peripheral wall of the centrifuge basket over at least 90% of its height, and the photodetection system is designed to detect over at least 90% of the height of the peripheral wall, the light reflected by the massecuite or the peripheral wall;
and in that the processing unit is designed to continuously process in real time the photodetection measurements performed over at least 90% of the height of the peripheral wall.

According to two variants, the centrifuge proposed in the invention may be a continuous centrifuge or a batch centrifuge.

The centrifuge comprises a measuring apparatus and a processing unit which are respectively designed to measure and analyze continuously, in other words in real time, and over at least 90% of the height of the permeable peripheral wall of the centrifuge basket of the centrifuge, photodetection measurements.

The processing unit can thus apply image processing functions to the photodetection measurements, ultimately making it possible to determine a colorimetric value of a colorimetric parameter which is representative of:
in the case of a continuous centrifuge, either: different viscosity states of the massecuite which, under the effect of centrifugal force, sticks to the peripheral wall; or the peripheral wall itself, more accurately the material from which it was made, which is therefore visible when nothing accumulates on it (massecuite or sugar crystals). The different viscosity states of the massecuite correspond to the different degrees of separation between the sugar crystals and the syrup.
in the case of a batch centrifuge: a change in the color of the massecuite, and/or its thickness.

This colorimetric value may refer to an ICUMSA color value which is a colorimetric parameter normatively used to monitor the color of the syrup, the massecuite, and the sugar.

Advantageously, the measuring apparatus and the processing unit make it possible to optimize the spinning step and to monitor in real time the evolution of the massecuite in its entirety, thus positively addressing the problem of a local measurement and its disadvantages outlined above.

Non exhaustively, the measuring apparatus and the processing unit make it possible to monitor the sugar content, to better regulate the separation of the sugar crystals and the syrup in the entire massecuite.

In the case of continuous centrifuges, the use of the measuring apparatus and the processing unit allows the operator to quickly detect the formation of “fingers” on the peripheral wall of the centrifuge basket, that is to say vertical areas/traces for which the massecuite covers a quantity of sugar crystals already separated from the syrup, to then spray water vapor at the arrival of the massecuite in the centrifuge basket in order to fluidize it and prevent the appearance of new fingers, a valve may be provided for this purpose. Thanks to the measurement provided by the invention, it is also possible to prevent the appearance of new fingers by modifying the flow rate of the massecuite arriving in the basket by monitoring for this the opening of a massecuite supply valve.

Advantageously, the light source of the measuring apparatus illuminates the peripheral wall of the centrifuge basket over at least 90% of its height, from its lower edge to its upper edge, thus making it possible to measure the entire massecuite contained in the centrifuge basket.

According to one feature of the invention, the photodetection system detects over at least 90% of the height of the peripheral wall, from its lower edge to its upper edge, light signals reflected by the massecuite or the peripheral wall, then converts these light signals into electrical detection signals which are then sent to the processing unit.

Advantageously, the photodetection system is designed and then disposed so that it detects over at least 90% of the height of the peripheral wall all the light signals reflected either by the entire massecuite contained in the basket, or in areas by the peripheral wall itself if no massecuite or sugar crystals have accumulated there. The photodetection system then converts all the light signals into electrical signals which correspond to the photodetection measurements which are transmitted to the processing unit.

The light source and the photodetection system are respectively designed so as to illuminate the peripheral wall of the centrifuge basket and detect the light reflected over at least 90% of the height of the centrifuge basket. Thus, they can respectively illuminate the peripheral wall of the centrifuge basket and detect the light reflected over the entire height of the centrifuge basket.

In the case of batch centrifuges, a monitoring carried out over the entire height of the basket advantageously makes it possible to monitor the color of the sugar in a more representative manner but also to detect whether the washing nozzles are partially or completely blocked, and to detect whether the sugar at the bottom of the basket remains dark, which shows wear of the scraping plow of the basket whose function is to scrape the massecuite.

For continuous centrifuges, a monitoring carried out over the entire height of the basket advantageously makes it possible to monitor the color of the sugar at the outlet of the basket, but also: to check and optimize the operation of each washing nozzle; to check that fingers have not formed; to check that the massecuite is being properly supplied by detecting whether there are any sugar-free areas in the basket.

According to one feature of the invention, the processing unit is designed to generate a raw image over at least 90% of the height of the centrifuge basket, from the photodetection measurements.

Advantageously, the processing unit renders in real time from all the photodetection measurements taken over the entire height of the peripheral wall by these electrical signals a raw image of the latter; the filtration orifices of the peripheral wall through which the syrup is evacuated to the chamber dedicated to its reception are also rendered if visible. From this raw image, the observer can for example determine the different viscosity states exhibited by the massecuite, what quantity of massecuite still needs to be treated during spinning, detect occasional absences of massecuite in the centrifuge basket, etc. The knowledge provided by the raw image makes it possible to positively address the second problem set out in the prior art, by no longer making spinning solely dependent on the performance of the monitoring apparatus and by enabling the operator to make decisions based on his observations/conclusions and to act quickly to better monitor and master this step.

According to one feature of the invention, the processing unit is designed to compare the photodetection measurements with a colorimetric limit over at least 90% of the height of the centrifuge basket, and to construct a secondary image having:
at least one first section of a first color in which the photodetection measurements are lower than said colorimetric limit; and/or
at least one second section of a second color in which the photodetection measurements are higher than said colorimetric limit.

The processing unit compares the photodetection measurements, measured over at least 90% of the height of the centrifuge basket, with a colorimetric limit. This is a “plateau” limit for which any color lighter than this means that the sugar crystals are separated from the syrup in the massecuite, while a darker color means that the sugar crystals and the syrup are still grouped/mixed in the massecuite. The processing unit then constructs from the results of these comparisons a secondary two-color image, each of the colors being able to define at least one section in which the colorimetric value is higher (respectively lower) than this colorimetric limit, i.e. a color lighter (respectively darker) than the “plateau” limit.

Advantageously, this secondary image makes it possible among others:
to identify possible defects that might be present in the peripheral wall and which would reduce its capacity to filter the syrup from the massecuite;
in the case of a batch centrifuge, to identify whether a washing ramp disposed opposite the peripheral wall to wash the massecuite is defective, for example because one or several washing nozzles composing it is/are blocked and cannot spray very hot water onto the massecuite, the secondary image then potentially highlights one or several areas of a first color corresponding to washed areas, and one or several areas of a second color corresponding to areas where washing has not been correctly (or not at all) carried out (in general, these areas correspond to dark horizontal lines over the height of the centrifuge basket);
in the case of a continuous centrifuge, to identify problems with the supply of the massecuite on the peripheral wall, as well as to accurately detect over the entire height of the peripheral wall, a clear interface line between a quantity of massecuite that has been treated, that is to say for which the sugar crystals have been separated from the syrup (or are well on the way to being separated), and a remaining quantity of massecuite still to be treated, allowing rapid and efficient decision-making with a view to optimizing further spinning.

According to one embodiment of the invention, when the centrifuge is a continuous centrifuge, the centrifuge comprises a vaporization system configured to send a water vapor at least inside the centrifuge basket and wherein the processing unit is designed to calculate a ratio between a surface area of the at least one first section and a surface area of the at least one second section, and to communicate a vaporization command according to said ratio, said vaporization command being transmitted by the processing unit to the vaporization system to trigger sending of water vapor.

Thus, the continuous centrifuge is equipped with a vaporization system capable of sending water vapor over at least 90% of the height of the peripheral wall in order to fluidize the massecuite. Indeed, the location of the interface line in the secondary image is a function of the viscosity state of the massecuite in the basket, and therefore this ratio is a function of the massecuite viscosity. Thus, the vaporization system is triggered by a vaporization command that the processing unit sends to the vaporization system. The quantity of water vapor sent into the centrifuge basket, or the vaporization duration, advantageously depends on information contained in the vaporization command and which is a function of this ratio.

According to one embodiment of the invention, when the centrifuge is a continuous centrifuge, the vaporization system is designed to send the water vapor inside the centrifuge basket at least at the bottom wall of the centrifuge basket.

The continuous centrifuge is supplied with massecuite by the supply system by means of a supply pipe which is in communication with the centrifuge basket at the lower area. The vaporization system is positioned opposite the outlet/first end of the supply pipe in order to begin to fluidize the untreated massecuite coming from the supply system and promote the separation of the sugar crystals from the syrup as soon as it arrives in the centrifuge basket, in order to promote the separation of the sugar crystals from the syrup and to make the spinning more efficient by reducing its completion time; but also to prevent the formation of fingers on the peripheral wall.

According to one feature of the invention, the processing unit is designed to distinguish several monitoring areas distributed over the height of the centrifuge basket, and to associate with each of the several monitoring areas a reference colorimetric value established from the photodetection measurements carried out in the corresponding monitoring area.

According to one embodiment of the invention, when the centrifuge is a continuous centrifuge, the centrifuge comprises a supply system designed to supply the centrifuge basket with massecuite, and for which the processing unit is designed to carry out a comparison of the reference colorimetric value with a colorimetric threshold in one of the several monitoring areas, called the lower area, which is closest to the lower edge of the centrifuge basket, and to communicate a supply command according to a result of said comparison, said supply command being transmitted by the processing unit to the supply system to supply the massecuite.

During the spinning during which the basket is driven in rotation (for example at constant speed in the case of a continuous centrifuge), the quantity of massecuite that was initially loaded into the basket before starting the spinning decreases as the sugar crystals and syrup are separated, which are evacuated into the chambers provided for this purpose. In the case of a continuous centrifuge, the centrifuge basket can be supplied with massecuite at a variable flow rate by a supply system while it is driven in rotation during spinning.

The processing unit is designed to segment the height of the peripheral wall into several monitoring areas and to associate a colorimetric value with each of them. In the case where the invention is implemented with a continuous centrifuge, one of the monitoring areas can correspond to an area called the lower area located as close as possible to the bottom wall of the centrifuge basket and from which it is connected to the supply system. The processing unit compares the colorimetric value of this lower area to a colorimetric threshold, which reflects a situation in which the centrifuge basket is almost empty. The result of the comparison is representative of the quantity of massecuite remaining in the centrifuge basket. The processing unit sends a supply command to the supply system so that it supplies the centrifuge basket with massecuite (if, of course, there is still massecuite to be treated) at a supply flow rate proportional to the quantity of massecuite remaining in the centrifuge basket.

According to one feature of the invention, for each of the several monitoring areas, the reference colorimetric value corresponds to an ICUMSA value.

The processing unit distinguishes several monitoring areas over at least 90% of the height of the centrifuge basket and will associate with each of them a colorimetric value of a colorimetric parameter. The value of the colorimetric parameter of a monitoring area is determined by the processing unit from the photodetection measurement(s) measured therein. As previously indicated, the colorimetric value may refer to an ICUMSA color value which is a colorimetric parameter normatively used to monitor the color of a massecuite and a quantity of sugar.

Advantageously, the segmentation of at least 90% of the height of the centrifuge basket into several monitoring areas allows the operator to locally observe and treat the massecuite.

According to one feature of the invention, the centrifuge comprises a washing device including:
at least one washing subassembly designed to spray a washing liquid on the peripheral wall of the centrifuge basket,
a control unit connected to the at least one washing subassembly and in communication with the processing unit to at least pilot the at least one washing subassembly according to the reference colorimetric value of at least one of the several monitoring areas.

According to one feature of the invention, for each of the several monitoring areas, the processing unit is designed to carry out a comparison of the reference colorimetric value with a colorimetric setpoint, and to communicate a washing command according to a result of said comparison, and the control unit is designed to pilot the at least one washing subassembly in order to monitor a washing flow rate, in response to a reception of the washing command.

In other words, in order to wash the massecuite, the centrifuge comprises a washing device which comprises at least one washing subassembly disposed at a certain height from the bottom wall and facing the at least one monitoring area. The processing unit compares the colorimetric value of the at least one monitoring area with a colorimetric setpoint reflecting whether it is necessary in this at least one monitoring area to wash the massecuite in order to separate the sugar crystals from the syrup and extract the impurities therefrom, or not, as the sugar crystals are cleaned. Following this comparison, the processing unit sends a washing command to the control unit responsible for piloting the at least one washing subassembly so that it washes or not the at least one monitoring area depending on the nature of the command.

According to one feature of the invention, the at least one washing subassembly comprises a valve which is connected to the control unit, and which is piloted to adjust the washing flow rate.

The at least one washing subassembly is designed to spray a liquid on the at least one monitoring area in front of which it is installed to wash the massecuite accumulating in said at least one monitoring area. The at least one washing subassembly has at its inlet a valve used to let the liquid pass at a given flow rate/intensity or to stop it. The valve of the at least one washing subassembly is connected and piloted by the control unit. Thus, depending on the washing command, the control unit gradually opens or closes the valve of the at least one washing subassembly proportionally to the flow rate/intensity of washing liquid to be sprayed on the monitoring area associated with the at least one washing subassembly.

According to one embodiment of the invention, when the centrifuge is a batch centrifuge, the at least one washing subassembly includes a single washing subassembly including several nozzles disposed at several heights from the bottom wall of the centrifuge basket.

In other words, in the case of a batch centrifuge, a single washing subassembly covers all the monitoring areas, meaning that when a washing command is sent to the control unit, all the monitoring areas are washed. The washing duration and/or intensity is/are a function of all the reference colorimetric values of each of the monitoring areas determined by the processing unit. An advantage of such a washing device is to ensure uniformity of the sugar color over all or part of the peripheral wall. Generally, only the washing duration is parameterized according to the needs, with maximum washing intensity. Washing is stopped during the acceleration phase of the centrifuge basket.

According to one embodiment of the invention, when the centrifuge is a continuous centrifuge, the at least one washing subassembly includes several washing subassemblies disposed at different heights from the bottom wall of the centrifuge basket, facing the several monitoring areas, each washing subassembly being associated with a monitoring area among the several monitoring areas, and wherein the control unit is connected to the different washing subassemblies and is in communication with the processing unit to at least independently pilot each of the washing subassemblies according to the reference colorimetric value of the monitoring area associated therewith.

According to one embodiment of the invention, when the centrifuge is a continuous centrifuge, the control unit is designed to independently pilot each of the washing subassemblies in order to monitor the corresponding washing flow rate, in response to a reception of the washing command resulting from the comparison of the reference colorimetric value of the monitoring area associated therewith, with the corresponding colorimetric setpoint.

In other words, the washing device consists of several washing subassemblies which are disposed facing the peripheral wall so that each washing subassembly covers one of the monitoring areas defined by the processing unit. The washing device, and therefore the washing subassemblies, are piloted independently of each other by the control unit which communicates with the processing unit.

Advantageously, such a device makes it possible to wash the massecuite locally in the centrifuge basket, in the monitoring area(s) in which the sugar crystals are still mixed with the syrup, the state of the massecuite in the different monitoring areas being in particular known through the values taken by the colorimetric value associated with a monitoring area. For each of the monitoring areas, each of the washing subassemblies sprays the washing liquid into the monitoring area with which it is associated at a certain intensity/a certain flow rate depending on the result of the comparison between the colorimetric setpoint and the reference colorimetric value of the monitoring area.

According to one feature of the invention, the light source is a white light source.

By definition, white light corresponds to sunlight during the day, that is to say which covers the entire light spectrum visible to the naked eye (for a wavelength, in a vacuum, between 380 nm and 780 nm), and therefore the set of colors: red, orange, yellow, green, blue green, blue, violet, dark violet.

Consequently, advantageously, the white light source offers a high chromatic yield for optimal color rendering of the objects it illuminates.

According to one feature of the invention, the light source is a stroboscopic source.

By definition, a stroboscopic source makes it possible to observe periodic phenomena whose frequency is too high for the eye which does not perceive the discontinuity, by alternating phases of very high light intensities (flashes) and dark phases. This source is useful in the real-time rendering of the image representative of the height of the peripheral wall. Indeed, the electrical signals processed by the processing unit from the light signals reflected by the height of the peripheral wall following its exposure to the stroboscopic source make it possible to observe with great clarity in real time, from this image, even very fast rotation or vibration movements of the centrifuge basket, as well as the separation of the sugar crystals from the syrup in the massecuite.

According to one feature of the invention, the light source consists of at least one light-emitting diode, and for example several light-emitting diodes.

In other words, the light source corresponds either to a light-emitting diode, or to an arrangement of light-emitting diodes mounted together on the same circuit. The number of light-emitting diodes depends on the surface area of the peripheral wall that is intended to be illuminated.

According to one feature of the invention, the photodetection system comprises at least one image sensor.

The function of the at least one image sensor included in the photodetection system is to convert the at least one light signal reflected by the peripheral wall when it is illuminated by the light source into an electrical signal that corresponds to a photodetection measurement.

According to one embodiment of the invention, the photodetection system comprises at least one matrix of color filters, for example of the RGB type.

The photodetection system comprises at least one matrix of color filters, for example of the RGB/RVB (Red, Green, Blue) and/or CMYG/CMJV (Cyan, Magenta, Yellow, Green) type, to generate from the photodetection measurement(s) a color image of the peripheral wall over at least 90% of its height.

According to one feature of the invention, the light source and the photodetection system of the measuring apparatus are disposed inside a sealed, closed housing fastened to an opening of a cover of the centrifuge, said housing being provided with a protective glass facing the opening of said cover and such that the light source and the photodetection system are behind said protective glass.

The light source and the photodetection system constituting the measuring apparatus are disposed inside a closed, sealed housing fastened to an opening of the cover of the centrifuge provided for this purpose. The housing is provided on one of its faces with a protective glass facing the opening and such that the light source and the photodetection system are behind said protective glass.

Thus, through the protective glass and via the opening on the cover, the light source (respectively the photodetection system) illuminates at least 90% of the height of the peripheral wall (respectively detects all of the light signals reflected by at least 90% of the height of the peripheral wall).

According to one feature of the invention, the housing is secured to a guide having a first end fastened to said housing, around the protective glass, and a second end fastened to the cover around its opening, said guide having at least one vent for entry of air into said guide.

Thus, the housing is placed in collaboration with the centrifuge by means of a guide, for example of rectangular shape, comprising two ends, the first end being fastened on the housing around the protective glass, and the second end being fastened on the cover of the centrifuge around the opening. The guide has at least one vent for entry of air inside. The guide has an angle of inclination so that advantageously, the light source (respectively the photodetection system) illuminates at least 90% of the height of the peripheral wall (respectively detects all the light signals reflected by at least 90% of the height of the peripheral wall).

According to one feature of the invention, the guide comprises at least one cleaning nozzle for cleaning the protective glass by spraying water.

Depending on the rotation speed of the centrifuge basket, it is possible that projections of sugar crystals or massecuite may splash and dirty the protective glass of the housing through the guide, meaning that the light source and the photodetection system can no longer operate under optimal conditions, with risks of inaccurate or, in the worst case, erroneous photodetection measurements which have a negative impact on the efficiency and relevance of the massecuite monitoring and the separation of the quantity of sugar crystals from the syrup.

Thus, to address this problem, it is expected that a cleaning nozzle, controlled by the control unit, opens into the guide in order to spray very hot water on the protective glass to clean it of any splashes.

According to one embodiment of the invention, at least 90% of the height of the peripheral wall of the centrifuge basket corresponds to the entire height of said peripheral wall taken from its lower edge to its upper edge.

The invention also relates to a centrifugal spinning method for separating, in a massecuite, a quantity of sugar crystals from a syrup using a centrifuge such as those previously described, and which comprises at least:
one centrifugation step in which the centrifuge basket in which the massecuite is present is actuated in rotation;
said centrifugal spinning method being characterized in that it comprises, during the centrifugation step:
a continuous illumination step consisting in illuminating, by the light source, the peripheral wall of the centrifuge basket over at least 90% of its height;
a continuous measurement step consisting in detecting by the photodetection system over at least 90% of the height of the peripheral wall of the centrifuge basket, the light reflected by the massecuite or the peripheral wall, in order to deliver photodetection measurements which are representative of the massecuite or the peripheral wall;
a step of continuously processing by the processing unit in real time the photodetection measurements carried out over at least 90% of the height of the peripheral wall.

According to one feature of the invention, the processing step implements a generation of a raw image over at least 90% of the height of the centrifuge basket, from the photodetection measurements.

In other words, during the processing step, the processing unit generates from all the photodetection measurements that it receives from the photodetection system an image representative of the peripheral wall over substantially its entire height.

According to one feature of the invention, during the processing step, the photodetection measurements are compared with a colorimetric limit over at least 90% of the height of the centrifuge basket, and comprises a step of constructing a secondary image having:
at least one first section of a first color in which the photodetection measurements are lower than said colorimetric limit; and/or
at least one second section of a second color in which the photodetection measurements are higher than said colorimetric limit.

In other words, during the processing step, the processing unit also generates, by comparing the colorimetric values deduced from the photodetection measurements with a colorimetric limit defined as a parameter by the operator, a two-color secondary image of at least 90% of the height of the peripheral wall, each of the two colors being representative of at least one first section for which the colorimetric value is higher than the colorimetric limit, meaning that the sugar crystals have been separated or are in the process of being separated from the syrup in the massecuite; and/or at least one second section for which the colorimetric value is lower than the colorimetric limit, meaning that the quantity of massecuite associated with this at least one second section is not yet treated.

According to one embodiment of the invention, when the centrifuge is a continuous centrifuge, the centrifugal spinning method comprises a step of calculating a ratio between a surface area of the at least one first section and a surface area of the at least one second section, and a vaporization step consisting in sending a water vapor at least inside the centrifuge basket according to said ratio.

In other words, the processing step comprises a calculation step during which the processing unit calculates a ratio between the surface area of the at least one first section and the surface area of the at least one second section, and which is representative of an overall viscosity of the massecuite. Depending on the value of this ratio, the method then implements or not a vaporization step, during which the processing unit issues a vaporization command to a vaporization system which is designed, according to the information contained in the command, to send water vapor into the centrifuge basket in a quantity and for a duration which are a function of the ratio value.

According to one feature of the invention, the processing step implements a distinction of several monitoring areas distributed over the height of the centrifuge basket, and an association with each of the several monitoring areas of a reference colorimetric value established from the photodetection measurements carried out in the corresponding monitoring area.

In other words, the ability offered by the processing unit to segment the height of the peripheral wall into several monitoring areas and to measure in real time a colorimetric value for each of the monitoring areas is implemented during the processing step of the centrifugal spinning method.

According to one feature of the invention, the centrifugal spinning method comprises an intermediate washing step for spraying a washing liquid on the peripheral wall of the centrifuge basket, according to the reference colorimetric value associated with at least one of the several monitoring areas.

According to one embodiment of the invention, when the centrifuge is a continuous centrifuge, the spinning method comprises, during the processing step and prior to the intermediate washing step, a comparison step during which the reference colorimetric value of each of the several monitoring areas is compared to a colorimetric setpoint, in order to spray a washing liquid at a washing flow rate according to the result of said comparison.

According to one embodiment of the invention, the intermediate washing step implements washing of each of the several monitoring areas, independently, according to the associated reference colorimetric value.

According to one embodiment of the invention, the centrifugal spinning method comprises, when the centrifuge is a continuous centrifuge:
a comparison step during which the reference colorimetric value in one of the several monitoring areas, called the lower area, which is closest to the lower edge of the centrifuge basket, is compared with a colorimetric threshold; and
a supply regulation step during which the centrifuge basket is supplied with massecuite according to a result of said comparison.

In other words, the centrifugal spinning method, when it is implemented by means of a continuous centrifuge, comprises an additional supply regulation step involving the aforementioned supply system, the role of which is to supply massecuite inside the centrifuge basket while the latter is driven in rotation during the centrifugation step. This step is implemented in the case where the entire massecuite could not be completely introduced into the centrifuge basket at one time during the loading step. The supply regulation step takes place continuously throughout the duration of the centrifugation spinning method, the massecuite flow rate introduced into the centrifuge basket by the supply system is variable such that it depends on the comparison result obtained following a comparison step carried out upstream during the processing step, during which the reference colorimetric value associated with the lower area of the peripheral wall is compared to the colorimetric threshold which reflects a situation for which the centrifuge basket is slightly filled or almost empty.

### BRIEF DESCRIPTION OF THE FIGURES

Other features and advantages of the present invention will appear on reading the following detailed description, of several non-limiting examples of implementation, made with reference to the appended figures in which:

FIG. 1 is a schematic cross-sectional view of a continuous centrifuge according to the invention, showing the measuring apparatus illuminating the peripheral wall of the centrifuge drum over at least 90% of its height, with the massecuite represented hatched and the quantity of sugar represented in white, and detecting/receiving the light signals reflected by the peripheral wall; which is divided into four monitoring areas by the processing unit piloting the measuring apparatus;

FIG. 2 is a schematic cross-sectional view of a batch centrifuge according to the invention, showing the measuring apparatus illuminating the peripheral wall of the centrifuge drum over at least 90% of its height, and detecting/receiving the light signals reflected by the peripheral wall; which is divided into four monitoring areas by the processing unit piloting the measuring apparatus;

FIG. 3 is a schematic cross-sectional view of the centrifuge basket of the continuous centrifuge of FIG. 1, for which the formation of massecuite fingers on the peripheral wall is illustrated; the hatched surface corresponding to the surface illuminated by the measuring apparatus;

FIG. 4 is a block diagram illustrating the environment of a centrifuge according to the invention and the different systems with which it interacts, such as for example the measuring apparatus piloted by the processing unit, or the washing system; the solid line elements correspond to all the devices that can interact with the continuous and batch centrifuges for the implementation of the spinning (the interactions between devices are represented by arrows), those in dashed lines are only present/used for spinning if the centrifuge considered is a continuous centrifuge;

FIG. 5 is an image showing the front face of the measuring apparatus, in the center of which the lens of the camera used as a photodetection system is visible, and on either side of which a printed circuit comprising an arrangement of several light-emitting diodes which illuminate the peripheral wall of the centrifuge basket is disposed;

FIG. 6 is a schematic side view showing the guide whose first and second ends are respectively fastened to the housing and to an opening in the centrifuge cover;

FIG. 7 is a flowchart illustrating the centrifugal spinning method implemented by the centrifuge;

FIG. 8 shows a flowchart describing the centrifugation step;

FIG. 9 shows a flowchart describing the processing step when it is implemented by a continuous centrifuge;

FIG. 10 shows a flowchart describing the processing step when it is implemented by a batch centrifuge;

FIG. 11 is an example of a raw image (on the left) and a secondary image (on the right) generated by the processing unit following the reception and processing of the photodetection measurements, with, for the raw image, the distinction by the processing unit of the four monitoring areas over at least 90% of the height of the peripheral wall;

FIG. 12 is a schematic cross-sectional view of the centrifuge basket of the continuous centrifuge of FIG. 1, for which the four monitoring areas distinguished by the processing unit on the peripheral wall are illustrated;

FIG. 13 is an example of the evolution of the reference colorimetric value over time associated with each of the other monitoring areas with the ICUMSA value taken by each of them on the ordinate; the solid curves correspond to the evolution of the colorimetric value while the dashed lines correspond to the colorimetric setpoints;

FIG. 14 is a schematic cross-sectional view of the centrifuge basket of the continuous centrifuge of FIG. 1, in which massecuite/sugar lack reveal the peripheral wall of the centrifuge basket, said peripheral wall thus being visible in these areas of lack and illustrated in dotted lines;

FIG. 15 is a schematic cross-sectional view of the centrifuge basket of the continuous centrifuge of FIG. 1, in which massecuite is represented as a hatched area while the part where the sugar crystals begin and then end to release from their mother liquor is represented in white, with a massecuite/sugar transition area at a given height from the bottom wall, and the associated secondary image is also illustrated;

FIG. 16 is a schematic view equivalent to that of FIG. 15, with a massecuite/sugar transition area at a so-called abnormal height, higher than that reached in the example of FIG. 15, and the associated secondary image is also illustrated.

### DETAILED DESCRIPTION OF ONE OR SEVERAL EMBODIMENTS OF THE INVENTION

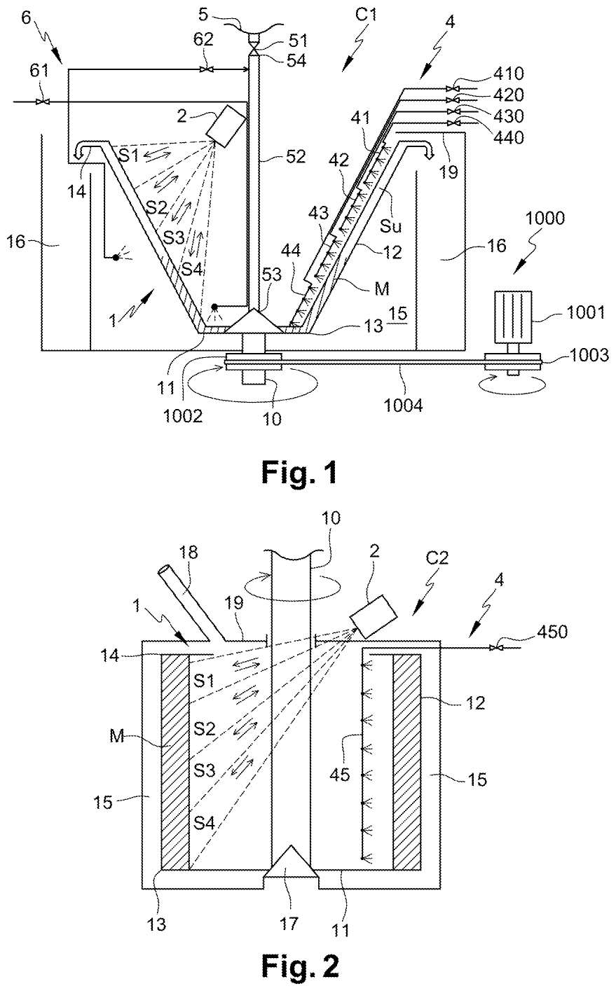

The invention concerns a centrifuge C1, C2 for separating, in a massecuite M, a quantity of sugar crystals Su from a syrup, which are designed to implement a centrifugal spinning method P1, P2 which is detailed later in the description. In a first embodiment of the invention, the invention concerns a continuous centrifuge C1, illustrated in FIG. 1. In a second embodiment of the invention, the invention concerns a batch centrifuge C2, illustrated in FIG. 2.

Commonly, the centrifuges C1, C2 comprise a centrifuge basket 1 (frustoconical in shape for the continuous centrifuge C1, and cylindrical in shape for the batch centrifuge C2) in which the massecuite M is introduced. The centrifuge basket 1 has a bottom wall 11; and a peripheral wall 12 which:
has a lower edge 13 contiguous to the bottom wall 11 and an upper edge 14;
has a height measured from its lower edge 13 to its upper edge 14;
is permeable over at least 90% of its height, and is generally in the form of a woven filter cloth, conventionally made of stainless steel, provided with perforations.

The centrifuge basket 1 is actuated in rotation about a central axis of rotation 10 set in rotational motion using a motorization system 1000. Several designs of motorization system 1000 are possible. For example, with reference to FIG. 1, the motorization system 1000 may comprise a first drive pulley 1002 and a second drive pulley 1003 coupled by means of a belt 1004; such that the first drive pulley 1002 is crossed in its center by the central axis of rotation 10 and the second drive pulley 1003 is crossed in its center by a motor axis of a motor 1001. The rotation of the motor 1001 induces a rotation of the second drive pulley 1003, which causes a movement of the belt 1004 and therefore a rotation of the first drive pulley 1002.

Under the action of centrifugal force, the sugar crystals Su are separated from the syrup (mother liquor) which is evacuated through the perforations of the peripheral wall 12 and collected in a chamber 15 provided for this purpose. The dimensions of the perforations are such that the sugar crystals Su cannot pass through. In the case of the continuous centrifuge C1, the sugar crystals Su rise along the peripheral wall 12 and are evacuated by overflowing the centrifuge basket 1, at the upper edge 14, in a second chamber 16 provided to collect them. In the case of the batch centrifuge C2, the sugar crystals Su when they are separated from the syrup remain on the surface of the peripheral wall 12. The basket 1 bottom is provided with a plug 17 which is closed throughout the duration of spinning, then opened at the end of the latter in order to discharge the quantity of sugar crystals Su by scraping.

In the following description, it is considered, for illustrative purposes, for FIGS. 1, 2, 3, 12, 14, 15 and 16 representing the centrifuge basket 1, that the hatched area(s) correspond(s) to the massecuite M, the white area(s) correspond(s) to the sugar Su when it is separated from the syrup (in other words the part(s) where the sugar crystals begin and then end to release from their mother liquor), and the dotted area(s) correspond(s) to the peripheral wall 12 (the points schematizing its perforations).

Each of the centrifuges C1, C2 comprises a washing device 4 which sprays a washing liquid, for example hot water or clear syrup, on all or part of the peripheral wall 12 to wash/fluidize the massecuite M, accelerating the separation of the sugar crystals Su from the syrup and cleaning the crystals of their impurities and mother liquor which are stuck to their surface. More specifically, the washing liquid is sprayed from the washing nozzles disposed at several heights from the bottom wall 11 of the centrifuge basket 1 and mounted on at least one washing subassembly opposite all or part of the peripheral wall 12. The at least one washing subassembly comprises several nozzles which spray the washing liquid on the peripheral wall 12.

In the case of a batch centrifuge C2, the washing device 4 comprises a single washing subassembly 45 for an overall washing of at least 90% of the height of the peripheral wall 12.

In the case of a continuous centrifuge C1, the washing device comprises at least two washing subassemblies disposed opposite two distinct surfaces of the peripheral wall 12, the at least two washing subassemblies being designed to spray the washing liquid independently, that is to say either simultaneously or not. It is considered that the washing device 4 comprises four washing subassemblies 41, 42, 43, 44 responsible for washing four distinct areas of the peripheral wall 12.

However, too intense and/or long spraying of washing liquid can lead to a risk of dissolving sugar crystals Su. For this reason, the at least one washing subassembly comprises at the inlet a proportional regulating valve in order to regulate the intensity/flow rate of the sprayed washing liquid. Thus, with reference to FIGS. 1 and 2, the washing device 4 comprises:
for the continuous centrifuge C1, four valves 410, 420, 430, 440 located respectively at the inlet of the washing subassemblies 41, 42, 43, 44;
for the batch centrifuge C2, a valve 450 located respectively at the inlet of the washing subassembly 45.

Unlike the batch centrifuge C2 for which the massecuite M is only introduced into the centrifuge basket 1 through a supply inlet 18 during the low speed phase dedicated to this operation, massecuite M is continuously introduced at a variable flow rate into the centrifuge basket 1 of the continuous centrifuge C1 during spinning by a supply system 5. With reference to FIG. 1, the massecuite M is introduced/deposited in the bottom wall 11 of the centrifuge basket 11 by exiting from the first end 53 of a supply pipe 52 partially entering inside the continuous centrifuge C1 via an access provided on its cover 19; the second end 54 of the supply pipe 52, outside the continuous centrifuge C1, being linked to a proportional regulating valve 51 at the outlet of the supply system 5, the progressive regulating valve 51 being able to progressively open and close to let a variable flow rate of massecuite M pass into the supply pipe 52.

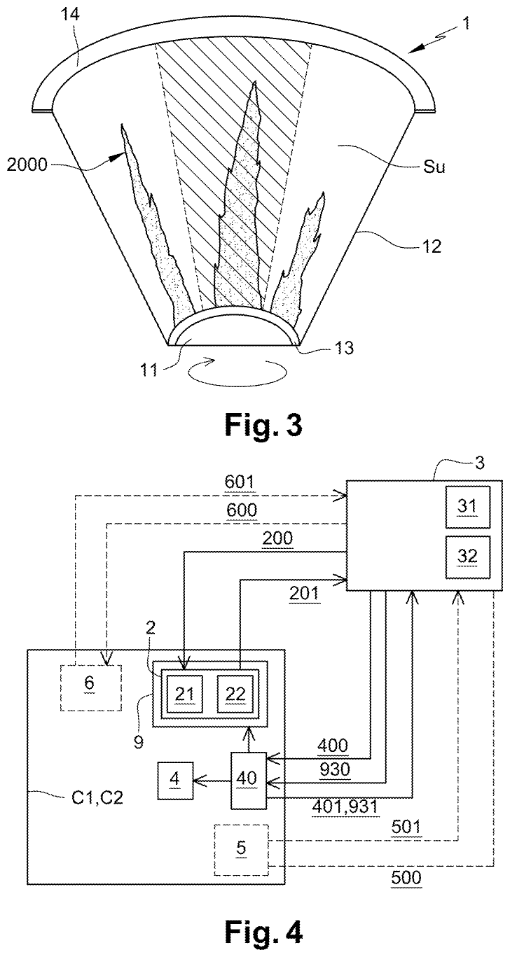

The continuous centrifuge C1 also comprises a vaporization system 6 designed to send at least one water vapor at least inside the centrifuge basket, in order to fluidize the massecuite M. The water vapor can be sprayed at the peripheral wall 12 in order to fluidize the massecuite M deposited thereon and to accelerate the separation of the sugar crystals Su from the syrup, and also to prevent the formation of massecuite fingers 2000 (see FIG. 3). In reference to FIG. 1, the water vapor is sprayed on the peripheral wall 12 from its outer face.

Water vapor can also be sprayed by the vaporization system 6 also at the bottom wall 11 in order to fluidize the massecuite M emerging in the centrifuge basket 1 from the first end 53 of the supply pipe 2.

The flow rate/intensity of water vapor sprayed on the peripheral wall 12 and/or into the bottom wall 11 is regulated by means of a proportional regulating valve 61. The vaporization system 6 sprays water vapor simultaneously on the peripheral wall 12 and the bottom wall 11.

The massecuite M can optionally also be fluidized inside the supply pipe 52 itself, which then has an opening through which a duct of the vaporization system 6 injecting the water vapor opens. According to two variants of the invention, said duct may or may not have a proportional regulating valve 62 for injecting, or not, water vapor into the supply pipe 52 according to the same flow rate of water vapor that is sprayed on the peripheral wall 12 and the bottom wall 11.

With reference to FIG. 1, FIG. 2, and FIG. 4, the centrifuge C1, C2 comprises a measuring apparatus 2 designed to:
illuminate the peripheral wall 12 of the centrifuge basket over at least 90% of its height, and therefore the massecuite M, by means of a light source 21;
detecting by means of a photodetection system 22 the light signals reflected by the illuminated area of the peripheral wall 12 and/or massecuite M; the photodetection system 22 then converting the light signals into electrical signals corresponding to photodetection measurements 201.

In the following description, it is considered that the measuring apparatus illuminates the entire height of the peripheral wall, from its lower edge 13 to its upper edge 14; and that it consequently detects all of the light signals reflected by the entire height of the peripheral wall 12.

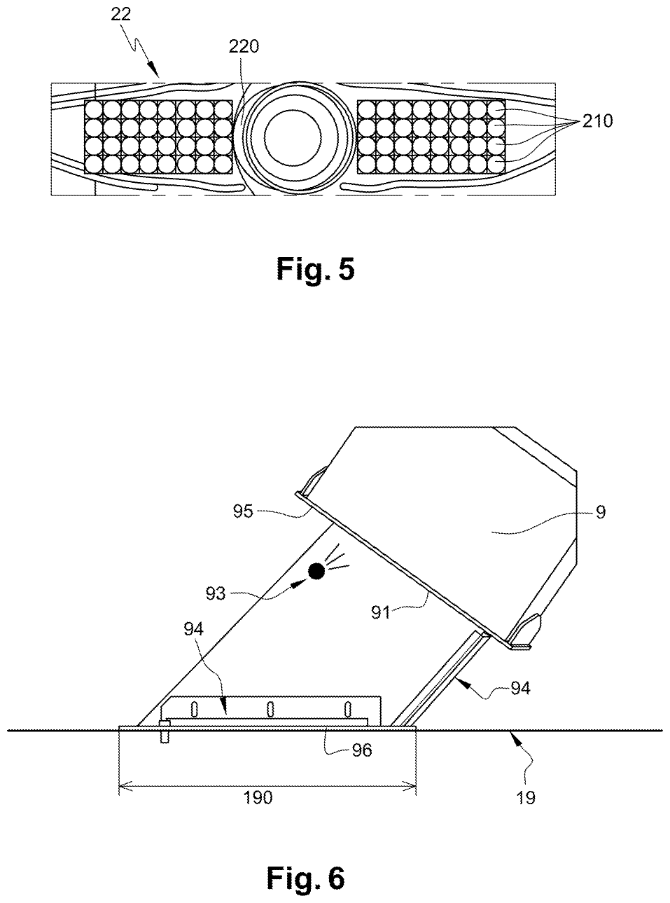

With reference to FIG. 5, the light source 21 of the measuring apparatus 2 consists of two arrangements of 4*8 light-emitting diodes 210, each of the two arrangements being disposed on a printed circuit and on either side of a camera 220 used as a photodetection system 22, and comprising at least one image sensor and a matrix of RGB-type color filters. In other embodiments of the invention, the photodetection system may comprise either at least one matrix of CMYG-type color filters, or at least one matrix of RGB color filters and at least one matrix of CMYG color filters.

With reference to FIG. 6, the measuring apparatus 2 is contained inside a sealed, closed housing 9 fastened to an opening 190 of the cover 19 of the centrifuge C1, C2. The housing 9 comprises a protective glass 91 facing the opening 190 of the cover 19 and behind which is the front face of the measuring apparatus 2. The front face of the measuring apparatus 2 therefore faces the opening 190.

The housing 9 is secured to a guide 92 having: a first end 95 fastened to the housing 9, around the protective glass 91; and a second end 96 fastened by screws on the cover 19 around its opening 190. It also comprises at least one vent 94 for entry of air inside.

The housing 9 cooperates with the first end 95 of the guide 92, which is rectangular, by means of hinges whose usefulness will be discussed later in the description. The guide 92 has two vents.

The guide 92 has an angle of inclination such that the light source 21 (respectively the photodetection system 22) of the measuring apparatus 2 illuminates the entire height of the peripheral wall 12 (respectively detects all the light signals reflected by the entire height of the peripheral wall 12).

The measuring apparatus 2 communicates, physically by connection cables or by means of a wireless communication protocol (such as WiFi® for example) with a processing unit 3 to which it transmits the photodetection measurements 201. The processing unit 3 is responsible for managing the progress of the centrifugal spinning method P1, P2 and for initiating or not steps of said centrifugal spinning method P1, P2 according to its analysis of the photodetection measurements 201.

The processing unit 3 comprises at least:
one display unit 31, such as a screen, designed to display for example: the parameters relating to the steps included in the centrifugal spinning method P1, P2; the photodetection measurements 201 received from the measuring apparatus 2 and their processing(s);
one adjustment unit 32, comprising a keyboard, and/or a touchpad, and/or buttons, designed so that an operator configures/parameterizes the measuring apparatus 2 as well as the steps of the centrifugal spinning method P1, P2;

According to different variants and as illustrative and non-limiting examples, the processing unit 3 is a computer (desktop; or portable; or on-board computer, for example of the fanless type) or even a processor, a controller, an electronic board on which software is installed allowing the centrifugal spinning method P1, P2 to be initiated and executed.

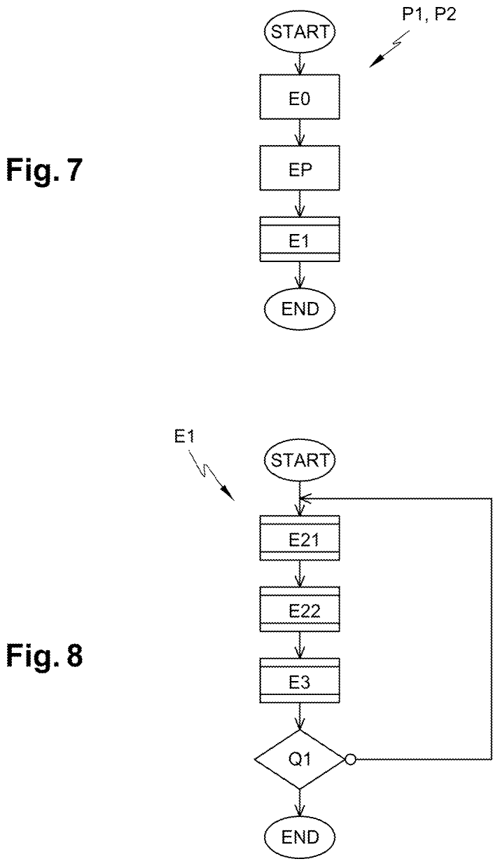

With reference to FIG. 7 and FIG. 8, the centrifugal spinning method P1, P2 comprises a centrifugation step E1 during which the centrifuge basket 1 is actuated in rotation in order to treat the massecuite M, all or part of which has been introduced beforehand into the centrifuge basket 1 during an initial supply step E0. The centrifugation step E1 is implemented and managed by the processing unit 3. Following the loading of the massecuite M into the centrifuge basket and before initiating the execution of the centrifugation step E1, the operator enters into the processing unit 3, during a parameterization step EP, a set of parameters allowing the configuration of the measuring apparatus 2 and/or the management of the steps included in the centrifugation step E1. According to the embodiments of the invention, the rotation speed of the centrifuge basket 1 can be parameterized from the processing unit 3 or from another device, such as for example a monitor/monitoring station integrated into the centrifuge C1, C2. It can also possibly be modified manually by the operator or automatically depending on the quantity of massecuite M contained in the centrifuge basket 1 and the speed at which the sugar crystals Su are separated from the syrup.

Once initiated, the centrifugation step E1 is managed automatically by the processing unit until the centrifugal spinning method P1, P2 is stopped. In a second variant of the invention, the centrifugation step E1 is semi-automatic, with the operator being able to intervene and change its parameters from the processing unit during its progress. In a third variant, the centrifugation step E1 is manual, with the operator himself triggering certain actions (washing; supplying of the centrifuge basket 1 and vaporization for the continuous centrifuge C1) according to the information provided by the processing unit 3 after processing of the photodetection measurements 201.

For the purposes of the invention, it is provided that the measuring apparatus 2, continuously and in real time throughout the duration of the centrifugation step E1:
illuminates during an illumination step E21 the peripheral wall 12 of the centrifuge basket 1 over at least 90% of its height (and for example over its entire height);
detects during a measurement step E22 over at least 90% of the height (and for example over the entire height) of the peripheral wall 12 the light signals reflected by the massecuite M or the peripheral wall 12, converts said light signals into electrical signals, and transmits for analysis the electrical signals, which correspond to the photodetection measurements 201, to the processing unit 3.

Thus, the processing unit is designed to continuously analyze in real time, during a processing step E3, all the photodetection measurements 201 sent by the measuring apparatus 2 and to trigger certain actions as required (such as fluidizing the massecuite by washing) according to the analysis results.

The continuous C1 and batch C2 centrifuges are designed to treat massecuite 24/7. They are only stopped if malfunctions are detected or if one-off interventions are necessary (maintenance, cleaning, unblocking, etc.) or if an emergency stop is triggered. Thus, during the processing step E3, the processing unit 3 checks during a checking step Q1, from all the information it receives from the other systems included in the centrifuge, whether a stop is controlled manually or automatically. If this is the case, the centrifugation step E1 and the centrifugal spinning method P1, P2 end.

The processing unit 3 may be, according to different embodiments of the invention, designed to control the starting and stopping of the measuring apparatus 2 respectively at the beginning and at the end of the spinning step E1 by sending a starting or stopping instruction 200 to the measuring apparatus.

During the processing step E3, the processing unit 3 applies image processing functions to the photodetection measurements 201 in order to deduce therefrom the colorimetric value of a colorimetric parameter representative for example of the different viscosity states that the massecuite M or even the peripheral wall 12 may have. The colorimetric value corresponds to an ICUMSA color value.

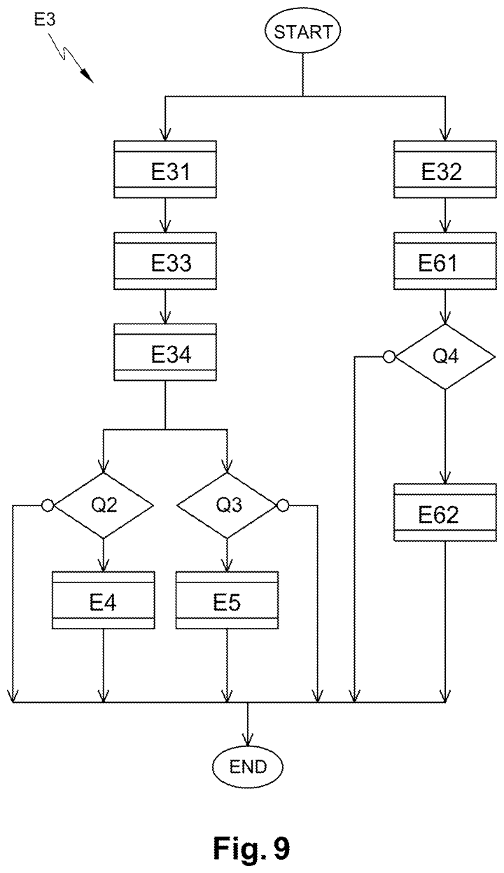

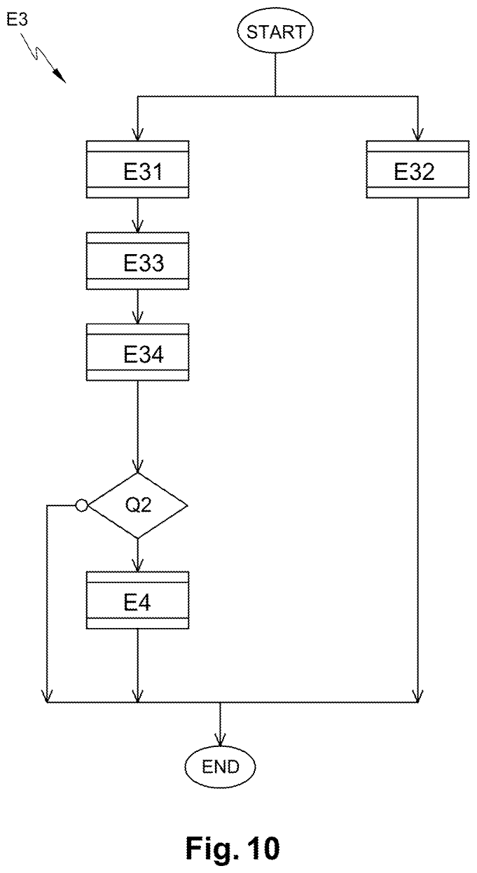

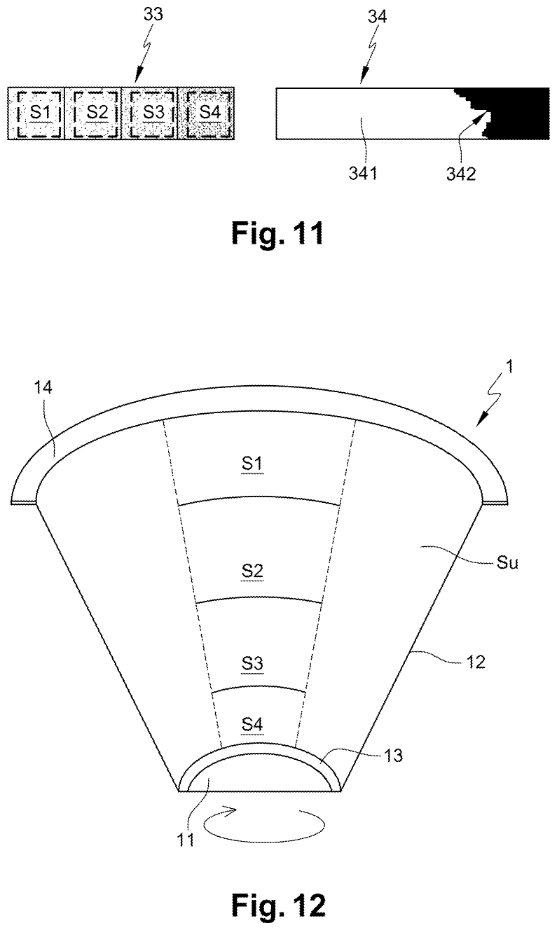

With reference to FIG. 9 to FIG. 11, the processing unit 3, when it receives new photodetection measurements 201;
implements a generation E31 of a raw image 33, displayed on the display unit 31, of at least 90% of the height (and for example of the entire height) of the peripheral wall 12 and of the massecuite M which can be deposited on it. The detection system 22 being a camera, the raw image 33 is a real-time color video image showing the operator, in a non-exhaustive way and as previously indicated: the evolution of the massecuite M treatment and the separation of the sugar crystals Su from the syrup, the different viscosity states of the massecuite M, to determine the quantity of massecuite M still to be treated (the raw image also rendering the peripheral wall 12 and its filtration orifices), makes it possible to observe the presence or formation of massecuite fingers 2000 on the peripheral wall 12 for the continuous centrifuge C1, etc.;
constructs during a construction step E32 a secondary image 34 of at least 90% of the height (and for example of the entire height) of the peripheral wall 12, similar to a map, based on a comparison between the colorimetric values deduced from the photodetection measurements 201 with a colorimetric limit, the secondary image 34 having: at least one first section 341 of a first color in which the photodetection measurements 201 are lower than said colorimetric limit; and/or at least one second section 342 of a second color in which the photodetection measurements 201 are higher than said colorimetric limit. The at least one first section 341 (in white in the Figure) corresponds to an area for which the sugar crystals Su are separated from the syrup or for which the massecuite M is well on the way to being treated; while the at least one second section 342 (in black in the Figure) corresponds to an area for which the massecuite M is untreated or still remains particularly viscous. As previously explained, the secondary image allows the operator to identify, in a non-exhaustive way, defects that the peripheral wall 12 would have (such as an obstruction of the filtration orifices), of the supply of massecuite M for the continuous centrifuge C1, or even a failure of the washing system 4 (in particular for the batch centrifuge C2).

According to the operating principle of the invention, the processing unit is designed to implement, after the generation 31 of the raw image 33, a distinction E33 during which it distinguishes over at least 90% of the height (and for example over the entire height) of the peripheral wall 12 several monitoring areas, at least two. In the embodiment shown through all the figures, the processing unit 3 distinguishes four monitoring areas S1, S2, S3, S4. Following this distinction E33, the processing unit associates during an association E34 a reference colorimetric value S1x, S2x, S3x, S4x with each of the monitoring areas S1, S2, S3, S4.

In order to determine the reference colorimetric values S1x, S2x, S3x, S4x, the processing unit averages the colorimetric values deduced from the photodetection measurements from the light signals reflected by each of the monitoring areas S1, S2, S3, S4.

In the embodiment shown, the reference colorimetric values S1x, S2x, S3x, S4x are therefore ICUMSA color values.

According to different variants of the invention, the several monitoring areas may or may not be substantially of the same height and surface area. For a given height of peripheral wall 12, it is also possible that the operator can define from the processing unit 3:
the number of monitoring areas, at least two;
the height of each of the several monitoring areas given that the lower the height of the monitoring areas is, the more accurate the reference colorimetric value will be. For example, for the continuous centrifuge C1, it may be interesting for the monitoring areas close to the bottom wall 11 to be defined by a suitable height so as to accurately determine whether or not there is still any massecuite M to be treated in the centrifuge basket 1.

In the embodiment shown, for both centrifugal spinning methods P1, P2, it is fixed in the design stage that the processing unit 3 distinguishes four monitoring areas S1, S2, S3, S4; each having a given height that cannot be modified.

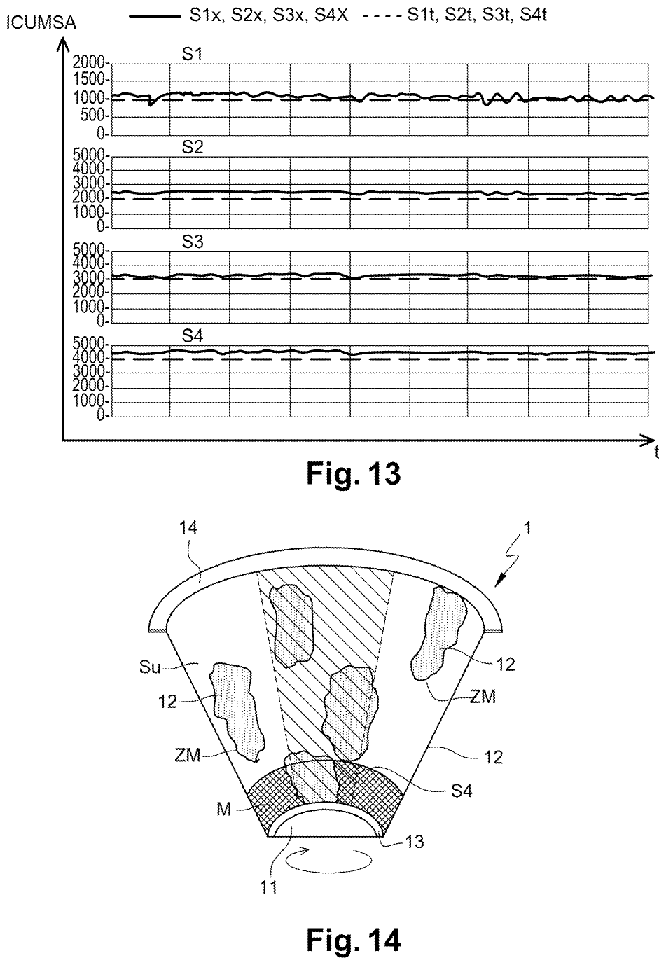

For both centrifugal spinning methods P1, P2, the reference colorimetric values are used to assess the need or not to spray washing liquid on the monitoring areas with which they are associated in order to clean the sugar crystals Su while minimizing their melting. Therefore, the reference colorimetric values are compared during a comparison step Q2 to a colorimetric setpoint reflecting whether it is necessary in this at least one monitoring area to wash the massecuite in order to separate the sugar crystals Su from the syrup and extract the impurities therefrom, or not because the sugar crystals Su are cleaned. With reference to FIG. 13, the reference colorimetric values S1x, S2x, S3x, S4x are thus each compared to a colorimetric setpoint S1t, S2t, S3t, S4t.

According to different variants of the invention, the colorimetric setpoints:
are fixed at the design stage or can be parameterized by the operator from the processing unit 3 before initiating the centrifugal spinning method P1, P2;
are all equal or can take different values.

If the processing unit 3 following the comparison step Q2 establishes that it is necessary to implement an intermediate washing step E4, the latter sends a washing command 400 to a control unit 40 piloting the washing system 4 so that it washes the peripheral wall 12.

According to the operating principle of the invention, a monitoring area is associated with at least one washing subassembly included in the washing system 4. Thus, a monitoring area can be associated with one or several washing subassemblies (two, three, etc.). If the result of the comparison between the reference colorimetric value of this monitoring area and the colorimetric setpoint assigned to it results in the need to wash, then the one or several washing subassemblies associated with the monitoring area will be actuated by the washing system 4 (via the control unit) during the intermediate washing step E4.

According to different embodiments of the invention, the operator can parameterize from the processing unit 3:
the number of washing subassemblies included in the washing system 4 (in the embodiments where the washing system would not be included with the centrifuges C1, C2 and would have to be installed later);
the allocation of a monitoring area to one or several washing subassemblies.

In the shown embodiment of the invention:
the washing system 4 of the continuous centrifuge C1 comprises four washing subassemblies 41, 42, 43, 44, each respectively associated, in the definition of the centrifugal spinning method P1, with a monitoring area S1, S2, S3, S4; and
that of the batch centrifuge C2 comprises a single washing subassembly 45 associated with all four monitoring areas S1, S2, S3, S4.

Thus, and as previously explained:
in the case of a batch centrifuge C2, the massecuite M washing takes place globally over at least 90% of the height (and for example over the entire height) of the peripheral wall 12. The washing subassembly 45 washes the peripheral wall as soon as the processing unit concludes for the at least one of the monitoring areas 41, 42, 43, 44 that it is necessary to wash;
in the case of a continuous centrifuge C1, the massecuite M washing can be carried out locally, with each of the washing subassemblies 41, 42, 43, 44 being piloted independently of each other by the control unit 40 according to the instructions contained in the washing command 400.

For the at least one washing subassembly, the washing command 400 comprises at least: one washing duration during which the at least one washing subassembly must wash the peripheral wall 12; and the intensity/flow rate at which the at least one washing subassembly will spray the washing liquid. The flow rate of sprayed washing liquid is regulated by means of a progressive regulating valve located at the inlet of the at least one washing subassembly and piloted by the control unit 40. It is understood that when the at least one washing subassembly does not spray washing liquid, the progressive regulating valve is completely closed. Thus:
for a continuous centrifuge C1, with reference to FIG. 1, each of the washing subassemblies 41, 42, 43, 44 is provided at the inlet with a proportional regulating valve 410, 420, 430, 440. The washing command comprises a washing duration and a washing flow rate specific to each of the washing subassemblies 41, 42, 43, 44 so as to be able to be independently piloted by the control unit 40;
for a batch centrifuge C2, with reference to FIG. 2, the single washing subassembly 45 is provided at the inlet with a proportional regulating valve 450. The washing command therefore only comprises a washing duration and a washing flow rate.

The at least one washing duration and the at least one flow rate are parameterized by the operator before initiating the centrifugal spinning method P1, P2.

According to different embodiments of the invention, the centrifuge C1, C2 is provided with at least one measuring device designed to measure the washing liquid flow rate at the at least one washing subassembly and to communicate the measurement 401 to the control unit 40, which then transmits it to the processing unit 3 so that it (and/or the operator if the centrifugal spinning method P1, P2 is semi-automatic or manual), as required, modifies during the washing step E4 the washing duration and/or the washing intensity relating to the at least one washing subassembly.

When the centrifuge is a continuous centrifuge C2, the centrifugal spinning method P2, compared to the centrifugal spinning method P1 of the batch centrifuge C1, comprises additional steps.

The several monitoring areas distinguished by the processing unit 3 comprise a monitoring area located as close as possible to the lower edge 13 of the centrifuge basket 1, called the lower area, which corresponds in the embodiment shown to the monitoring area S4.

In the following explanation, it is considered that the lower area corresponds to the lower area S4.

Following association E34 of a reference colorimetric value S1x, S2x, S3x, S4x with each of the monitoring areas S1, S2, S3, S4, the processing unit 3 executes a comparison step Q3 during which the reference colorimetric value S4x of the lower area S4 is compared to a colorimetric threshold.

FIG. 14 shows an example of an application context that can be observed in a continuous centrifuge C1, for which areas of lack ZM of massecuite/sugar are present in the centrifuge basket 1, these areas of lack ZM thus revealing the peripheral wall 12 (the peripheral wall 12 being represented in dotted lines in this FIG. 14); such areas of lack ZM being, thanks to the invention, detectable on all the monitoring areas S1, S2, S3, S4 and in particular in the lower area S4.

In this context of FIG. 14, the reference colorimetric value S4x is representative of the massecuite M. On the other hand, if the massecuite M is not introduced in sufficient quantity into the centrifuge basket 1 (for example if it is too viscous or if there is a malfunction in the supply system), one or several areas of lack ZM begin to appear on the peripheral wall 12 in the lower area S4. Thus, the reference colorimetric value S4x is representative of the remainder of the massecuite M to be treated and of the peripheral wall 12. It is to this situation, for which the centrifuge basket 1 is almost empty, that the colorimetric threshold relates/corresponds.

If the processing unit concludes following the comparison step Q3 that the centrifuge basket is almost empty, it sends a supply command 500 to the supply system 5 to supply the centrifuge basket 1 with massecuite M, thus implementing a supply regulation step E5. The processing unit 3 sends the supply command 500 under the condition that massecuite M remains to be treated. Therefore, the supply system 5 communicates beforehand with the processing unit 3 to send it, among a set of information 501, information relating to the presence or absence of a quantity of massecuite M still to be treated.

The supply command 500 comprises at least one supply duration during which the supply system 5 must supply the centrifuge basket 1 with massecuite M, and a supply flow rate. Depending on the requested supply flow rate, the supply system gradually opens or closes the proportional regulating valve 51 to let a variable flow rate of massecuite M pass in the supply pipe 52. According to a variant of the invention, the set of information 501 communicated by the supply system 5 to the processing unit comprises the flow rate of massecuite M circulating in the supply pipe 52, so that the processing unit 3 (and/or the operator if the centrifugal spinning method P1 is semi-automatic or manual) can modify/regulate the supply flow rate and/or the supply duration as required during the supply regulation step E5.

By default, the supply duration and supply flow rate values are entered by the operator during the parameterization step EP from the processing unit 3. It also defines the colorimetric threshold value.

According to different embodiments of the invention, the supply system 5 has at least one measuring device designed to measure the massecuite M flow rate supplying the centrifuge basket 1, and to communicate the massecuite flow rate measurement 501 to the processing unit 3. Depending on the massecuite flow rate measurement 501, the processing unit 3 (and/or the operator if the centrifugal spinning method P1 is semi-automatic or manual) can modify the requested supply flow rate value and/or the supply duration during the supply step E5.

The centrifugal spinning method P1 also comprises a step E61 of calculating a ratio taking place after the construction step E32 from the secondary image 34, between a surface area of the at least one first section 341 and a surface area of the at least one second section 342. As previously indicated, the ratio reflects a general viscosity state of the massecuite M.

By comparing the ratio to a threshold ratio during a comparison Q4, the processing unit 3 determines whether or not it is necessary to send water vapor into the centrifuge basket 1 to fluidize the massecuite M. If so, the processing unit 3 sends a vaporization command 600 to the vaporization system 6 for the implementation of a vaporization step E62, during which it sprays water vapor into the centrifuge basket 1, at least at the bottom wall 11 and, as in the embodiment shown, at the peripheral wall 12.

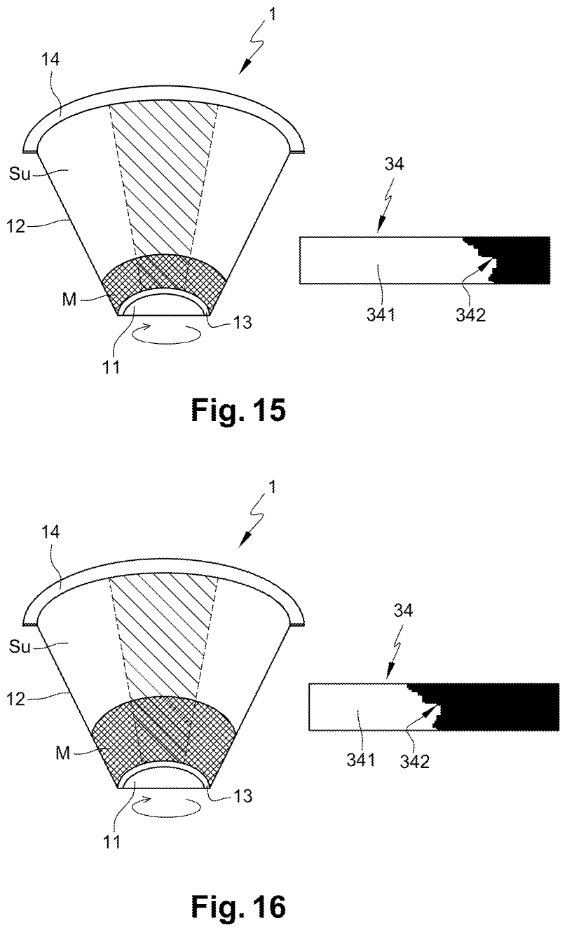

In the example of FIG. 15, the massecuite M/sugar S transition area is located at a given height from the bottom wall, which is a normal treatment height, which is reflected in the associated secondary image 34 by a ratio (that resulting from the calculation step E61) above the threshold ratio, so that no vaporization command 600 is issued.

On the other hand, in the example of FIG. 16, the massecuite M/sugar S transition area is located at another given height from the bottom wall, which is a so-called abnormal height that is greater than the normal treatment height of FIG. 15, which is reflected this time in the associated secondary image 34 by a ratio (that resulting from the calculation step E61) below the threshold ratio, so that a vaporization command 600 is issued.

The vaporization command 600 comprises at least one vaporization duration during which the vaporization system 6 sprays water vapor into the centrifuge basket and a vaporization flow rate to adjust the spray intensity. The spray intensity is physically adjusted by the vaporization system which pilots the proportional regulating valve 61 according to the specified vaporization flow rate value.

In the embodiment shown, as mentioned above, the vaporization system can also, as required, fluidize the massecuite M circulating inside the supply pipe 52 before it arrives in the centrifuge basket.

In the case where the processing unit 3 implements the vaporization step E6 simultaneously with the supply step E5, the vaporization command 600 can comprise a second vaporization duration and a second vaporization flow rate corresponding respectively to the duration and intensity of water vapor injected by the vaporization system 6 into the supply pipe; the water vapor regulation being managed by the vaporization system 6 by means of a proportional regulating valve 62, which is completely closed if water vapor does not have to be injected into the supply pipe 52.

The operator enters by default during the parameterization step from the processing unit 3 the vaporization duration, the vaporization flow rate, and the threshold ratio value. In the embodiment shown, it also enters the second vaporization duration and the second vaporization flow rate.

According to different embodiments of the invention, the vaporization system 6 has at least one measuring device designed to measure at least the intensity of water vapor injected into the supply pipe 52 and/or that sprayed into the centrifuge basket 1, and to communicate the vaporization measurement(s) 601 to the processing unit 3. Depending on the vaporization measurement(s) 601, the processing unit 3 (and/or the operator if the centrifugal spinning method P1 is semi-automatic or manual) can modify the requested vaporization flow rate value(s) and/or the vaporization duration(s) during the vaporization step E6.

Depending on the rotation speed of the centrifuge basket, it is possible that projections of sugar crystals Su or massecuite may splash and dirty the protective glass 91 of the housing 9 through the guide, meaning that the light source 21 and the photodetection system 22 can no longer operate under optimal conditions. For this reason, the guide 92 of the centrifuges C1, C2 is equipped with a cleaning nozzle 93 opening into the guide 92 in order to spray very hot water on the protective glass to clean it of any splashes.

The cleaning of the protective glass is carried out at regular intervals throughout the duration of the centrifugation step E1 of the centrifugal spinning method P1, P2. Therefore, the processing unit sends a cleaning command 930 to the control unit 40 which pilots the cleaning nozzle 93 so that it sprays or not very hot water on the protective glass 91, respectively by opening or closing an on/off valve located at the inlet of the cleaning nozzle 93.

According to different embodiments of the invention, the operator can enter during the parameterization step EP from the processing unit 3 the cleaning duration, the time interval separating each cleaning. In the embodiment shown, the cleaning intensity is a predefined value and the time interval separating each cleaning is equal to fifteen minutes.

1. A centrifuge for separating, in a massecuite, a quantity of sugar crystals from a syrup, the centrifuge comprising at least:
a centrifuge basket actuated in rotation about a central axis of rotation, into which the massecuite is intended to be introduced, the centrifuge basket having a bottom wall and a peripheral wall, the peripheral wall being permeable and having a lower edge contiguous to the bottom wall and an upper edge, and wherein the peripheral wall has a height measured from the lower edge to the upper edge;
a measuring apparatus comprising at least one light source for illuminating the interior of the centrifuge basket and a photodetection system for detecting reflected light and delivering photodetection measurements that are representative of the massecuite or the peripheral wall; and
a processing unit connected to the measuring apparatus for receiving and processing the photodetection measurements;
the centrifuge wherein the light source is designed to illuminate the peripheral wall of the centrifuge basket over at least 90% of its height, and the photodetection system is designed to detect over at least 90% of the height of the peripheral wall the light reflected by the massecuite or the peripheral wall;
and in that the processing unit is designed to continuously process in real time the photodetection measurements performed over at least 90% of the height of the peripheral wall.

2. The centrifuge according to claim 1, for which the processing unit is designed to generate a raw image over at least 90% of the height of the centrifuge basket, from the photodetection measurements.

3. The centrifuge according to claim 2, wherein the processing unit is designed to compare the photodetection measurements with a colorimetric limit over at least 90% of the height of the centrifuge basket, and to construct a secondary image having:
at least one first section of a first color in which the photodetection measurements are lower than the colorimetric limit; and/or
at least one second section of a second color in which the photodetection measurements are higher than the colorimetric limit.

4. The centrifuge according to claim 3, for which the centrifuge is a continuous centrifuge comprising a vaporization system designed to send a water vapor at least inside the centrifuge basket, and wherein the processing unit is designed to calculate a ratio between a surface area of the at least one first section and a surface area of the at least one second section, and to communicate a vaporization command according to the ratio, the vaporization command being transmitted by the processing unit to the vaporization system to trigger sending of water vapor.

5. The centrifuge according to claim 4, wherein the vaporization system is designed to send the water vapor inside the centrifuge basket at least at the bottom wall of the centrifuge basket.

6. The centrifuge according to claim 1, for which the processing unit is designed to distinguish several monitoring areas distributed over the height of the centrifuge basket, and to associate with each of the several monitoring areas a reference colorimetric value established from the photodetection measurements carried out in the corresponding monitoring area.

7. The centrifuge according to claim 6, for which the centrifuge is a continuous centrifuge which comprises a supply system designed to supply the centrifuge basket with massecuite, and for which the processing unit is designed to carry out a comparison of the reference colorimetric value with a colorimetric threshold in one of the several monitoring areas, called the lower area, which is closest to the lower edge of the centrifuge basket, and to communicate a supply command according to a result of the comparison, the supply command being transmitted by the processing unit to the supply system to supply the massecuite.

8. The centrifuge according to claim 6, wherein, for each of the several monitoring areas, the reference colorimetric value corresponds to an ICUMSA value.

9. The centrifuge according to claim 6, comprising a washing device including:
at least one washing subassembly designed to spray a washing liquid on the peripheral wall of the centrifuge basket,
a control unit connected to the at least one washing subassembly and in communication with the processing unit to at least pilot the at least one washing subassembly according to the reference colorimetric value of at least one of the several monitoring areas.

10. The centrifuge according to claim 9, wherein, for each of the several monitoring areas, the processing unit is designed to carry out a comparison of the reference colorimetric value with a colorimetric setpoint, and to communicate a washing command according to a result of the comparison,
and the control unit is designed to pilot the at least one washing subassembly in order to monitor a washing flow rate, in response to a reception of the washing command.

11. (canceled)

12. The centrifuge according to claim 9, wherein the at least one washing subassembly includes a single washing subassembly including several nozzles disposed at several heights from the bottom wall of the centrifuge basket.

13. The centrifuge according to claim 9, wherein the at least one washing subassembly includes several washing subassemblies disposed at different heights from the bottom wall of the centrifuge basket, facing the several monitoring areas, each washing subassembly being associated with a monitoring area among the several monitoring areas, and wherein the control unit is connected to the different washing subassemblies and is in communication with the processing unit to at least independently pilot each of the washing subassemblies according to the reference colorimetric value of the monitoring area associated therewith.

14. The centrifuge according to claim 10, wherein the control unit is designed to independently pilot each of the washing subassemblies in order to control the corresponding washing flow rate, in response to a reception of the washing command resulting from the comparison of the reference colorimetric value of the monitoring area associated therewith, with the corresponding colorimetric setpoint.

15-19. (canceled)

20. The centrifuge according to claim 1, wherein the light source and the photodetection system of the measuring apparatus are disposed inside a sealed, closed housing fastened to an opening of a cover of the centrifuge, the housing being provided with a protective glass facing the opening of the cover and such that the light source and the photodetection system are behind the protective glass.

21. The centrifuge according to claim 20, for which the housing is secured to a guide having a first end fastened on the housing, around the protective glass, and a second end fastened on the cover around its opening, the guide having at least one vent for entry of air into the guide.

22. The centrifuge according to claim 21, wherein the guide comprises at least one cleaning nozzle for cleaning the protective glass by spraying water.

23. The centrifuge according to claim 1, for which at least 90% of the height of the peripheral wall of the centrifuge basket corresponds to the entire height of the peripheral wall taken from its lower edge to its upper edge.

24. A centrifugal spinning method for separating, in a massecuite, a quantity of sugar crystals from a syrup, using a centrifuge according to claim 1, and which comprises at least:
one centrifugation step in which the centrifuge basket in which the massecuite is present is actuated in rotation;
the centrifugal spinning method comprises, during the centrifugation step:
a continuous illumination step consisting in illuminating by the light source the peripheral wall of the centrifuge basket over at least 90% of its height;
a measurement step consisting in detecting by the photodetection system over at least 90% of the height of the peripheral wall of the centrifuge basket the light reflected by the massecuite or the peripheral wall, in order to deliver photodetection measurements which are representative of the massecuite or the peripheral wall;
a step of continuously processing in real time by the processing unit the photodetection measurements performed over at least 90% of the height of the peripheral wall.

25-27. (canceled)

28. The centrifugal spinning method according to claim 24, wherein the processing step implements a distinction of several monitoring areas distributed over the height of the centrifuge basket, and an association with each of the several monitoring areas of a reference colorimetric value established from the photodetection measurements carried out in the corresponding monitoring area.

29-31. (canceled)

32. The centrifugal spinning method according to claim 28, for which the centrifuge is a continuous centrifuge, and comprising:
a comparison step during which the reference colorimetric value in one of the several monitoring areas, called the lower area, which is closest to the lower edge of the centrifuge basket, is compared with a colorimetric threshold; and
a supply regulation step during which the centrifuge basket is supplied with massecuite according to a result of the comparison.
